(19) United States
(12) Patent Application Publication
(10) Pub. No.: US 2005/0256796 A1
(43) Pub. Date: Nov. 17, 2005

(54) Mutual rating system, and terminal device and program for use in same system

(76) Inventors: Tomoyuki Haga, Kadoma (JP); Ryuichi Okamoto, Kadoma (JP); Mitsuhiro Inoue, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/523,194

(22) PCT Filed: Nov. 6, 2003
(86) PCT No.: PCT/JP03/14130

§ 371 Date: Jan. 27, 2005

(30) Foreign Application Priority Data
Nov. 8, 2002 (JP) NO-2002-325814

(51) Int. Cl. G06F 17/00; G06F 3/00; G06F 9/00; G06F 17/60

(52) U.S. Cl. 705/37; 705/1; 715/751

(57) ABSTRACT

The present invention provides a mutual rating system in which objects, such as users, content, and terminal devices, on the network can be rated and ratings for the objects can be checked without using a server. In the rating system, objects (users, content, terminal devices, etc.) associated with a network (3) are rated. The mutual rating system is connected to the network (3), and includes: a plurality of third party terminals (1(#3)) having stored therein rating information related to objects previously rated by the user; and content demanding terminal devices (1(#1)) for collecting rating information related to desired objects from all online rating information stoning terminal devices. Each content demanding terminal device (I(# I )) analyzes rating information collected from the third party terminal devices (1(#3)) to obtain a rating for a desired object.

### TECHNICAL FIELD

The present invention relates to a system for rating contents, users, terminal devices, etc., on a network, and more particularly to a system in which the users on the network provide ratings on a mutual basis.

### BACKGROUND ART

In recent years, significant attention has been paid to online auctions, peer-to-peer file exchange systems, etc., where product transactions, content exchanges, etc., are conducted between the users on a network (see, for example, Naoki Ito, “P2P computing—Technical Description and Application thereof”, Soft Research Center Inc., December 2001). In an online auction, the users on the network conduct transactions of various products. In a file exchange system, the users on the network exchange contents with each other. In the file exchange system, the user who wishes to obtain content uses his/her own terminal device to designate a desired content to a terminal device of the owner of music, dynamic image, still image contents, and downloads the desired content via the network.

In the online auction or the file exchange system, transactions or exchanges of products or contents are conducted between the users unknown to each other, and therefore it is very important to know whether the transaction or exchanging partner is reliable. The users on the network rate other users based on their transaction experiences with them, thereby providing ratings for the reliability of the transaction or exchanging partner.

In the file exchange system, the users who have exchanged contents rate each other, thereby providing ratings for the reliability of the exchanging partners. In the online auction, the users rate the transaction partners by comments or points.

For example, in the Yahoo!(R) auctions, there is a “Rate Seller” system. In this system, a successful bidder rates the seller, and the seller is rated by three grades, i.e., “good”, “neither good nor bad”, and “bad”.

A rating is determined in the following manner. In order to rate the user (the buyer or seller), the user selects a rating for the buyer or seller from among “good”, “neither good nor bad”, and “bad”, and writes comments on the buyer or seller. Each user can write the comments in their respective styles. However, the buyer or seller is rated by three grades as described above, and therefore it is possible to quantify the rating. Views of the users who have recently experienced transactions with the buyer or seller are reflected in the rating for the buyer or seller. Rating points are determined in accordance with the grades of rating as shown below.

In the case of a positive comment, +1 is added as a rating point, while in the case of a negative comment, −1 is added as a rating point. Further, in the case of a neutral comment, 0 is given as a rating point.

The mechanism of rating is as follows. For example, (1) in the first transaction between user A (buyer) and user B (seller), the buyer was happy and rated the user B as “good”, and therefore the user B has a rating of +1 from the user A; (2) in the second transaction that took place between the users A and B, the user B was slow in sending the item, so that the user A rated the user B as “bad”, and therefore the user B has a rating of −1 from the user A.

The users can check aggregated points as to “good”, “bad”, and “neither good nor bad” from aggregated data for the past six months, the past month, and the past week.

In the above-described conventional rating system, rating information related to a specific user provided by other users is managed in the server. Accordingly, the server requires its own manager, causing a problem related to the cost of managing the server.

Further, in the above-described rating system, some users may conspire with each other so as to maliciously rate a specific user. In the case of using the server, the manager of the server can manage ratings for that specific user, and therefore it is possible to prevent such conspiracy. However, when the server is not used, it is difficult to prevent such conspiracy.

Furthermore, the rating information is manually inputted by the user, and therefore it is not ensured that the users who had transactions always input ratings.

### DISCLOSURE OF THE INVENTION

Therefore, an objective of the present invention is to provide a system in which ratings for objects, such as the user, contents, terminal devices, etc., on the network, can be provided and checked without using a server.

To achieve the above objectives, the present invention has the following aspects.

A first aspect of the present invention is directed to a mutual rating system for rating an object associated with a network. The mutual rating system includes: a plurality of rating information storing terminal devices connected to the network, each rating information storing terminal device having stored therein rating information related to an object previously rated by the user; and one or more rating information collecting terminal devices for collecting rating information related to a desired object from one or more online rating information storing terminal devices. Each rating information collecting terminal device includes a rating analyzing section operable to analyze the rating information collected from said one or more rating information storing terminal devices to obtain a rating for the desired object.

Preferably, the mutual rating system may further include one or more content providing terminal devices each having content stored therein and transmitting the content on demand, and each rating information collecting terminal device may further include a content demanding section operable to demand a content providing terminal device having the desired content stored therein to transmit the desired content.

In this case, each rating information storing terminal device may further include a download history storing section having stored therein a communication history of content downloaded from said one or more content providing terminal devices, each rating information collecting terminal device may further include a communication history collecting section operable to, when demanding said one or more content providing terminal devices to transmit the desired content, collect a communication history related to said one or more content providing terminal devices stored in online rating information storing terminal devices, and the rating analyzing section may analyze the communication history collected by the communication history collecting section to determine whether to download the desired content from a content providing terminal device having the desired content stored therein.

Further, the download history storing section may store the communication history so as to be associated with content types, and the rating analyzing section may refer to the content types to determine whether to demand content transmission.

Preferably, said one or more content providing terminal devices each may include an upload history storing section into which a communication history of content uploaded to the rating information collecting terminal devices is stored, and said one or more content providing terminal devices each may determine whether to perform content upload based on the communication history stored in the upload history storing section.

In this case, the upload history storing section may store the communication history so as to be associated with content types, and said one or more content providing terminal devices each may refer to the content types to determine whether to perform the content upload.

Further, each rating information collecting terminal device may further include: a rating information input section operable to cause, after the completion of download of the desired content, the user to input rating information related to said one or more content providing terminals and/or content providers of the desired content, and to store the inputted rating information; and a rating information feeding back section operable to feedback the rating information stored by the rating information input section to other rating information collecting terminal devices and rating information storing terminal devices on the network, and each rating information storing terminal device may further include a fed back rating information storing section which uses a prescribed technique to analyze the rating information fed back from the rating information feeding back section, and stores the analyzed rating information.

Alternatively, each rating information collecting terminal device may further include a rating information storing section having stored therein the rating information related to the objects previously rated by the user, and each rating information storing terminal device may further include: a rating information collecting section operable to collect the rating information related to the desired object from one or more online rating information collecting terminal devices; and a collected rating information analyzing section operable to analyze the rating information collected by the rating information collecting section to obtain a rating for the desired object.

A second aspect of the present invention is directed to a rating information collecting terminal device for obtaining rating information related to an object associated with a network to which a plurality of rating information storing terminal devices are connected, each rating information storing terminal device having stored therein rating information related to objects previously rated by the user. The rating information collecting terminal device includes: a rating information collecting section operable to collect rating information related to a desired object from one or more online rating information storing terminal devices; and a rating analyzing section operable to analyze the rating information collected by the rating information collecting section to obtain a rating for the desired object.

For example, the rating information collecting section may collect the rating information from said one or more rating information storing terminal devices only when a prescribed condition is satisfied.

Alternatively, the rating information collecting section may collect the rating information from all the online rating information storing terminal devices.

Alternatively still, the rating information collecting section may collect the rating information from a specific rating information storing terminal.

For example, the object may be a user on the network, an online terminal device, or content stored in the online terminal device.

Preferably, the rating information collecting terminal device may further include a reliability information storing section having stored therein reliability information which indicates reliabilities of the rating information storing terminal devices and/or rating information providers present on the network, and when obtaining a rating result, the rating information analyzing section may refer to the reliability information stored in the reliability information storing section and prioritize rating information provided by highly reliable rating information storing terminal devices and/or highly reliable rating information providers.

In this case, the rating information analyzing section may use weighting coefficients assigned as the reliabilities to the reliability information to obtain a weighted average, and thereby to obtain the rating result.

Alternatively, the rating information collecting terminal device may further include a content demanding section operable to demand transmission of desired content from one or more content providing terminal devices connected to the network, each content providing terminal device having content stored therein and transmitting the content on demand.

In this case, the content demanding section may automatically demand content transmission from said one or more content providing terminal devices based on a rating result obtained by the rating analyzing section.

Alternatively, the rating information collecting terminal device may further include a download history storing section to which a communication history of content downloaded from said one or more content providing terminal devices, and the content demanding section may determine whether to demand content transmission based on the communication history stored in the download history storing section.

Further, the download history storing section may store the communication history so as to be associated with content types, and the content demanding section refers to the content types to determine whether to demand the content transmission.

Typically, the rating information collecting terminal device further includes a rating information input section operable to cause, after the completion of download of the desired content, the user to input rating information related to said one or more content providing terminal devices and/or content providers of the desired content, and to store the inputted rating information.

In this case, the rating information collecting terminal device may further include a rating information feeding back section operable to feedback the rating information stored by the rating information input section to other rating information collecting terminal devices and rating information storing terminal devices present on the network.

The rating information feeding back section may transmit the rating information stored by the rating information input section to all the online rating information collecting terminal devices and all the online rating information storing terminal devices.

Alternatively, the rating information feeding back section may transmit the rating information stored by the rating information input section only to a specific rating information collecting terminal device and/or a specific rating information storing terminal device.

In this case, the rating information feeding back section may transmit the rating information stored by the rating information input section to rating information collecting terminal devices and/or rating information storing terminal devices which have returned rating information in response to a demand to transmit the rating information.

Alternatively, the rating information feeding back section may transmit the rating information stored by the rating information input section to rating information collecting terminal devices and/or rating information storing terminal devices which have returned rating information, which is different from the rating information stored by the rating information input section, in response to a demand to transmit the rating information.

Preferably, the rating information collecting terminal device may further include a rating information updating section operable to update the rating information stored therein based on rating information fed back from another rating information collecting terminal device.

More preferably, the rating information collecting terminal device may further include a fed back information transmitting section operable to transmit rating information, which has been fed back from another rating information collecting terminal device, to still another rating information collecting terminal device.

Still more preferably, the rating information collecting terminal device may further include a content rating information input section operable to cause, after reproduction of the desired content, the user to input rating information related to the desired content, and to store the inputted rating information.

For example, the rating information may indicate rating points for the objects.

Alternatively, the rating information may indicate distribution of the rating points for the objects.

A third aspect of the present invention is directed to a mutual rating system for rating an object associated with a network. The mutual rating system includes: a plurality of terminal devices each being connected to the network and having stored therein rating information related to objects previously rated by the user, wherein each terminal device includes: a rating information collecting section operable to collect the rating information from other online terminal devices; and a rating analyzing section operable to analyze the rating information collected by the rating information collecting section to obtain a rating for a desired object.

A fourth aspect of the present invention is directed to a rating information obtaining program executed by a terminal device for obtaining rating information related to an object associated with a network to which a plurality of rating information storing terminal devices are connected, each rating information storing terminal device having stored therein rating information related to objects previously rated by the user, the rating information obtaining program causing the terminal device to perform the steps of: collecting rating information related to a desired object from one or more online rating information storing terminal devices; and analyzing the collected rating information to obtain a rating for the desired object.

In the present invention, rating information storing terminal devices connected the network own rating information about objects. Accordingly, when the rating information is required, each rating information collecting terminal device is able to collect the rating information from other terminal devices, and therefore the rating information storing terminal devices connected the network are able to mutually check ratings for objects without using a central server. Further, content transactions and product transactions can be conducted based on the ratings for objects, for example. Furthermore, various objects are rated on the network, and therefore various transactions are promoted on the network.

Each rating information collecting terminal device is able to collect the rating information from all the online rating information storing terminal devices, and therefore it is possible to obtain the rating information as much as possible to obtain a rating result of a desired object, whereby it is possible to obtain a rating result having a higher reliability.

Each rating information collecting terminal device collects the rating information only when a prescribed condition is satisfied, thereby efficiently collecting the rating information.

Alternatively, each rating information collecting terminal device collects the rating information only from specific terminal devices, thereby efficiently collecting the rating information.

When a user, a terminal device, or content is rated as an object, it is expected that only good-mannered users or terminal devices and content of good quality are naturally selected within the network.

Rating information provided by highly reliable terminal devices or users has a more considerable influence on a rating result, and therefore by prioritizing the rating information provided by highly reliable terminal devices or users, it is made possible to obtain a more reliable rating result. More over, rating information provided by unreliable users, etc., tends to be ignored, and therefore it is possible to prevent specific users from conspiring with each other so as to lower a rating for a specific object.

When a rating result is obtained based on reliabilities to which weighting coefficients are assigned, each rating information collecting terminal device is able to readily obtain a reliable rating result by prioritizing highly reliable rating information.

Each rating information collecting terminal device (each content demanding terminal device) is able to obtain a desired content from content providing terminal devices on the network.

When a demand on the content providing terminal device to transmit content is automatically generated, whether to demand content transmission is determined based on a rating result, and therefore the inconvenience for the user to make a demand to transmit content is eliminated.

In the case where whether to demand content transmission is determined based on a communication history stored in the download storing section, for example, when it is found that previous communication has not succeeded by reference to the communication history, the rating information collecting terminal device (the content demanding terminal device) is able to determine not to demand content transmission.

In the case where whether to demand content transmission is determined by reference to content types, the rating information collecting terminal device (the content demanding terminal device) is able to determine not to download content which is hard to be downloaded.

In the case the communication history is analyzed to determine whether to download a desired content from the content providing terminal device, the rating information collecting terminal device (the content demanding terminal device) is able to collect the communication history from other terminal devices on the network, and therefore it is possible to determine whether to download the desired content based on a larger amount of information, resulting in more correct determination.

In the case where whether to upload content is determined based on a communication history stored in the upload history storing section, the content providing terminal device is able to determine not to upload content to a terminal device which is hard to communicate with.

In the case where whether to upload content is determined by reference to content types, the content providing terminal device is able to determine not to upload content to a terminal device which is hard to be uploaded.

By causing the user to input rating information related to a content providing terminal device and/or a content provider and to store the inputted rating information, the rating information is inputted without fail. Accordingly, the entire system of the present invention is able to accumulate a larger amount of rating information, whereby it is possible to contribute the establishment of a network through which information of higher quality is provided.

By feeding back the rating information, it is made possible to automatically providing the rating information to other terminal devices on the network. Accordingly, terminal devices other than the rating information collecting terminal device is able to obtain the latest rating information.

By feeding back the rating information only to specific terminal devices, it is made possible to efficiently utilize communication environment on the network, while provide the latest rating information to the specific terminal devices.

In the case where rating information stored in a terminal device is updated based on rating information fed back from other terminal devices, it is possible to obtain rating information in which a larger number of users' views are reflected.

By transmitting the rating information fed back from other terminal devices to further terminal devices, the rating information is distributed all over the network, thereby establishing a network in which rating information about objects mutually rated between user terminal devices is stored in each terminal device.

In the case where the rating information fed back from other user terminal devices are analyzed and stored in the rating information storing terminal device, the stored rating information can be utilized when performing content download in the future.

Both the rating information storing terminal device and the rating information collecting terminal device can collect and stored the rating information, and therefore all the terminal devices on the network have both a function of collecting the rating information and a function of storing the rating information.

### BRIEF DESCRIPTION OF THE DRAWINGS

FIG. 1 is a diagram illustrating the overall configuration of a mutual rating system according to a first embodiment of the present invention;

FIG. 2 is a block diagram of a user terminal device 1 according to the first embodiment of the present invention;

FIG. 3A is a table illustrating an exemplary data structure of rating information;

FIG. 3B is a table illustrating an exemplary data structure of reliability information;

FIG. 4A is a diagram illustrating an exemplary rating input screen;

FIG. 4B is a diagram illustrating another exemplary rating input screen;

FIG. 5 is a diagram illustrating an exemplary reliability input screen;

FIG. 6 is a chart illustrating the operation of the entire mutual rating system according to the first embodiment;

FIG. 7A is an exemplary structure of a rating information demand message;

FIG. 7B is an exemplary structure of a rating information response message;

FIG. 8 is a flowchart illustrating the operation of a content demanding terminal device (a rating information collecting terminal device);

FIG. 9 is a flowchart illustrating the operation of a content providing terminal device;

FIG. 10 is a flowchart illustrating the operation of a third party terminal device (a rating information storing terminal device);

FIG. 11 is a table illustrating another example of the rating information;

FIG. 12 is a table illustrating an exemplary data structure of the rating information in the case where contents obtained from content providers are rated;

FIG. 13 is a diagram illustrating the structure of a user terminal device 11 according to a second embodiment of the present invention;

FIG. 14 is a table illustrating an exemplary data structure of transmission/reception history information;

FIG. 15 illustrate flowcharts showing the operation of a content demand monitoring section 114 of a content demanding terminal device (a rating information collecting terminal device) according to the second embodiment and the operation of a content transmission monitoring section 113 of the content providing terminal device according to the second embodiment;

FIG. 16 is a table illustrating exemplary transmission/reception history information in which the number of successes and failures of content exchange is associated with content types;

FIG. 17A illustrates an exemplary data structure of feedback information transmitted by a rating and reliability information registering section 109;

FIG. 17B illustrates another exemplary data structure of the feedback information transmitted by the rating and reliability information registering section 109; and

FIG. 18 is a flowchart illustrating the operation of the rating and reliability information registering section 109.

### BEST MODE FOR CARRYING OUT THE INVENTION

### First Embodiment

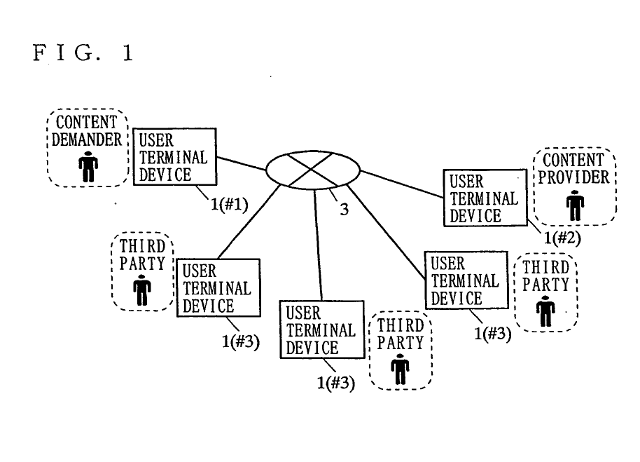

FIG. 1 is a diagram illustrating the overall configuration of a mutual rating system according to a first embodiment of the present invention. In FIG. 1, the mutual rating system includes a plurality of user terminal devices 1 mutually connected via a network 3. Although the number of the user terminal devices 1 shown in FIG. 1 is five, less than five user terminal devices 1 or six or more user terminal devices 1 may be used.

Each user terminal device 1 is a so-called information processing terminal device capable of performing a process of inputting/outputting and storing information, such as a computing device (e.g., a personal computer), a digital set-top box capable of controlling a household electrical apparatus or the like, a mobile telephone, or a personal digital assistant (PDA). The network 3 is an information transmission medium allowing intercommunication between information processing terminal devices, and is implemented by the Internet, a local area network (LAN), or the like. In the network 3, a communications protocol, such as TCP/IP, is used for data transmission/reception between the terminal devices.

Each user terminal device 1 in the mutual rating system performs different processes in different situations. In the case where the user demands content, the user terminal device 1 functions so as to collect and analyze rating information related to the owner of desired content from other user terminal devices and to download the desired content from the user terminal device of the content owner. Hereinafter, the user terminal device which functions in the above-described manner is also referred to as the “content demanding terminal device” or “rating information collecting terminal device”. In FIG. 1, sign (#1) is added to the content demanding terminal device. Note that the owner of content to be rated is referred to as the “object”.

Alternatively, in the case of accepting a demand from a content demanding terminal device, the user terminal device 1 functions so as to transmit demanded content to the content demanding terminal device. Hereinafter, the user terminal device which functions in the above-described manner is also referred to as the “content providing terminal device”. In FIG. 1, sign (#2) is added to the content providing terminal device.

In addition to the content demanding terminal device 1 (#1) and the content providing terminal device 1 (#2), the mutual rating system includes a user terminal device for transmitting rating information related to the owner of the content providing terminal device 1(#2) to the content demanding terminal device 1(#1) In FIG. 1, sign (#3) is added to such a terminal device. (hereinafter, also referred to as the “third party terminal device” or “rating information storing terminal device”).

The user who wishes to obtain a content (hereinafter, also referred to as the “content demander”) uses his/her own user terminal device 1 (#1) to download the content from the user terminal device 1 (#2) of the owner of the content (hereinafter, also referred to as the “content provider”). In response to a demand from the user terminal device 1 (#1), the user terminal device 1 (#3) owned by the third party returns the rating information related to the content provider to the user terminal device 1 (#1) In response to a demand from the user terminal device 1 (#1) owned by the content demander, the user terminal device 1 (#2) owned by the content provider transmits required content.

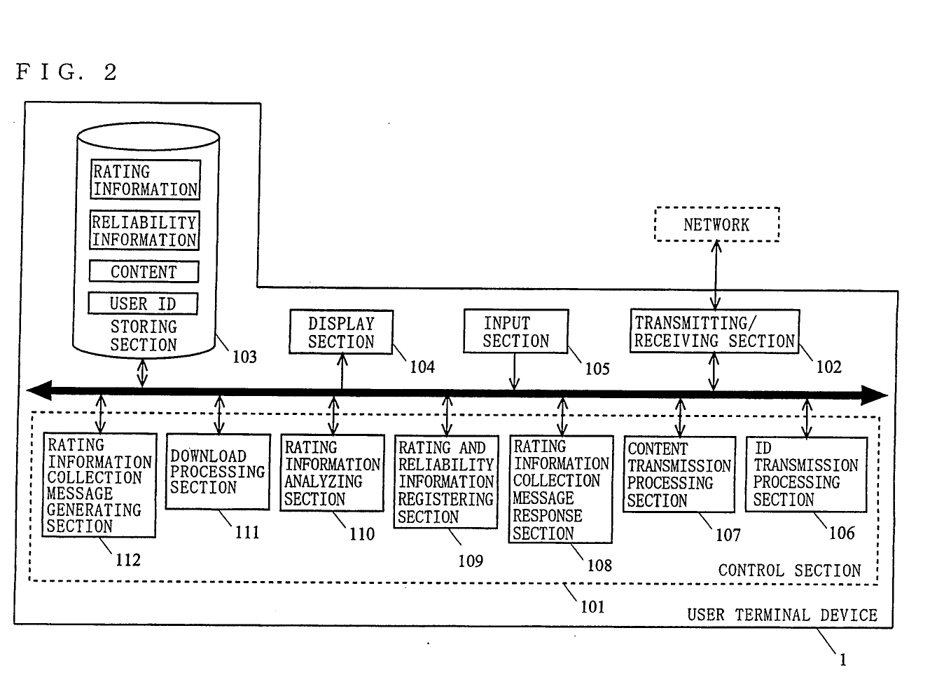

FIG. 2 is a block diagram of the user terminal device 1 according to the first embodiment of the present invention. In FIG. 2, the user terminal device 1 includes: a control section 101; a transmitting/receiving section 102; a storing section 103; a display section 104; and an input section 105.

The storing section 103 is a storing device, such as a hard disc or a memory, and has stored therein rating information, reliability information, contents, and a user ID of the owner of the terminal device l. The term “rating information” as described herein refers to information indicating ratings for the users with whom the owner of the terminal device 1 has ever conducted content transactions. A rating is represented by a value associated with the user ID of the user to whom the rating is given. The term “reliability information” as described herein refers to information indicating the reliability of the users with whom the owner of the terminal device 1 has ever conducted content transactions.

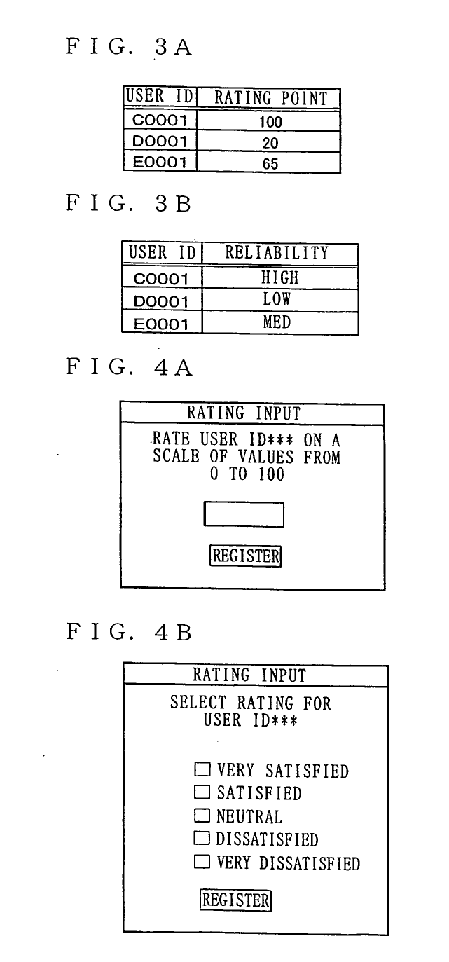

FIG. 3A is a table illustrating an exemplary data structure of the rating information. As illustrated in FIG. 3A, in the rating information, ratings by the user are digitized as rating points associated with the user IDs of content providers. In FIG. 3A, for example, the rating point of the content provider having user ID “C0001” is indicated as “100”. In this case, a rating point of “0” is the lowest rating, and a rating point of “100” is the highest rating. Each rating point is inputted by the user after the user has obtained content.

FIG. 3B is a table illustrating an exemplary data structure of the reliability information. As illustrated in FIG. 3B, in the reliability information, reliabilities of users present on the network are registered so as to be associated with a corresponding one of user IDs. In FIG. 3B, for example, the reliability of the user having user ID “C0001” is indicated as “HIGH”. When the reliability of the user is “HIGH”, the user is considered as being highly reliable. When the reliability of the user is “MED”, the user is considered as being generally reliable. When the reliability of the user is “LOW”, the user is considered as being hardly reliable.

The transmitting/receiving section 102 is a modem or the like which transmits/receives information to/from another user terminal device 1 on the network. The transmitting/receiving section 102 uses, for example, TCP/IP as a communications protocol.

The display section 104 is a liquid crystal panel or display, or the like, which displays a necessary instruction screen or a content reproduction screen in accordance with the instruction from the control section 101. The input section 105 is an operating button, a keyboard, or the like, which conveys the details of user inputs to the control section 101.

The control section 101 includes: an ID transmission processing section 106; a content transmission processing section 107; a rating information collection message response section 108; a rating and reliability information registering section 109; a rating information analyzing section 110; a download processing section 111; and a rating information collection message generating section 112. In the case of demanding content, i.e., in the case where the user terminal device 1 functions as a content demanding terminal device, the rating information collection message generating section 112, the rating and reliability information registering section 109, the rating information analyzing section 110, and the download processing section 111 are operated. In the case of transmitting content, i.e., in the case where the user terminal device 1 functions as a content providing terminal device, the ID transmission processing section 106 and content transmission processing section 107 are operated. In the case of transmitting the rating information to another user terminal device 1, i.e., in the case where the user terminal device 1 functions as a third party terminal device, the rating information collection message response section 108 is operated.

The control section 101 is a specialized microcomputer or the like having function parts. Each function part is implemented by a program masked by the microcomputer or the like. Note that each function part may be an individual microcomputer.

The rating information collection message generating section 112 obtains the user ID of the content provider from the content providing terminal device. The rating information collection message generating section 112 generates a message for collecting the rating information from third party terminal devices (hereinafter, such a message is referred to as the “rating information demand message”), and then broadcasts (i.e., simultaneously transmits) the rating information demand message to the third party terminal devices on the network via the transmitting/receiving section 102. In order to broadcast the rating information demand message, the transmitting/receiving section 102 uses a broadcasting IP address for use in TCP/IP, etc.

The rating information analyzing section 110 receives messages (hereinafter, referred to as the “rating information response messages”), which are transmitted by the third party terminal devices in accordance with the rating information demand message, and analyzes the rating information related to the content provider contained in the rating information response messages. The rating information analyzing section 110 causes the display section 104 to display an analysis result, while causing the storing section 103 to store the rating information. The user refers to the analysis result displayed on the display section 104 to determine whether to download the content. When the user has determined to download the content, the user inputs an instruction to download the content to the input section 105.

In accordance with the user's instruction provided via the input section 105, the download processing section 111 causes the transmitting/receiving section 102 to download the content from the content providing terminal device, and stores the downloaded content into the storing section 103.

The rating and reliability information registering section 109 displays on the display section 104 a screen for inputting a rating for the content provider (hereinafter, referred to as the “rating input screen”) and a screen for inputting the reliability of the content provider (hereinafter, referred to as the “reliability input screen”). The rating and reliability information registering section 109 stores in the storing section 103 the rating as rating information and the reliability as reliability information, which are respectively inputted via the rating input screen and the reliability input screen, such that the rating information and the reliability information are associated with the user ID of the content provider.

In response to a demand from a content demanding terminal device, the ID transmission processing section 106 reads the user ID of the content provider from the storing section 103, and transmits the user ID to that content demanding terminal device via the transmitting/receiving section 102. In response to a demand from a content demanding terminal device, the content transmission processing section 107 reads desired content from the storing section 103, and transmits that content demanding terminal device.

The rating information collection message response section 108 receives a rating information demand message transmitted by the content demanding terminal device, and reads from the storing section 103 the rating information related to the content provider designated by the rating information demand message. The rating information is transmitted to the content demanding terminal device via the transmitting/receiving section 102.

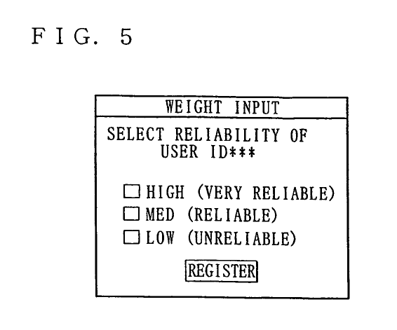

FIG. 4A is a diagram illustrating an exemplary rating input screen. The rating input screen is displayed on the display section 104 by the rating and reliability information registering section 109 when the download processing section 111 completes content downloading. The rating input screen prompts the user to input a rating for the content provider. The rating is inputted as a point in the range from 0 to 100. The rating point of “0” corresponds to the lowest rating, and the rating point of “100” corresponds to the highest rating. When a register button is pressed, the rating and reliability information registering section 109 stores into the storing section 103 the input rating point as the rating information together with the user ID of the content provider.

FIG. 4B is a diagram illustrating another exemplary rating input screen. As illustrated in FIG. 4B, the rating input screen may be displayed in such a manner as to allow the user to select a rating from among predetermined alternatives, rather than to input a numerical value. For example, the user selects a rating for the content provider from among alternatives such as “very satisfied”, “satisfied”, “neutral”, “dissatisfied”, and “very dissatisfied”. In this case, the rating and reliability information registering section 109 stores the rating information into the storing section 103 such that the alternatives “-very satisfied”, “satisfied”, “neutral”, “dissatisfied”, and “very dissatisfied” are counted as rating points of “100”, “80”, “50”, “30”, and “0”, respectively. In this manner, numerical values are previously mapped to corresponding alternatives, and therefore ratings for the users on the network can be handled as numerical values. Note that alternatives used for ratings are not limited to the alternatives as described above, and any alternatives may be used so long as different degrees of rating are clearly provided.

FIG. 5 is a diagram illustrating an exemplary reliability input screen. After the rating input screen is closed, the reliability input screen is displayed on the display section 104 by the rating and reliability information registering section 109. In a weight input screen shown as an exemplary reliability input screen in FIG. 5, the user selects the reliability of the content provider from among three alternatives, i.e., “HIGH”, “MED”, and “LOW”, and presses a “REGISTER” button to cause the rating and reliability information registering section 109 to associate the selected reliability with the user ID of the content provider and to store, as the reliability information, the selected reliability into the storing section 103. Note that FIG. 5 merely illustrates an example of selecting the reliability, and the reliability can be selected in any manner so long as the level of the reliability can be clearly specified.

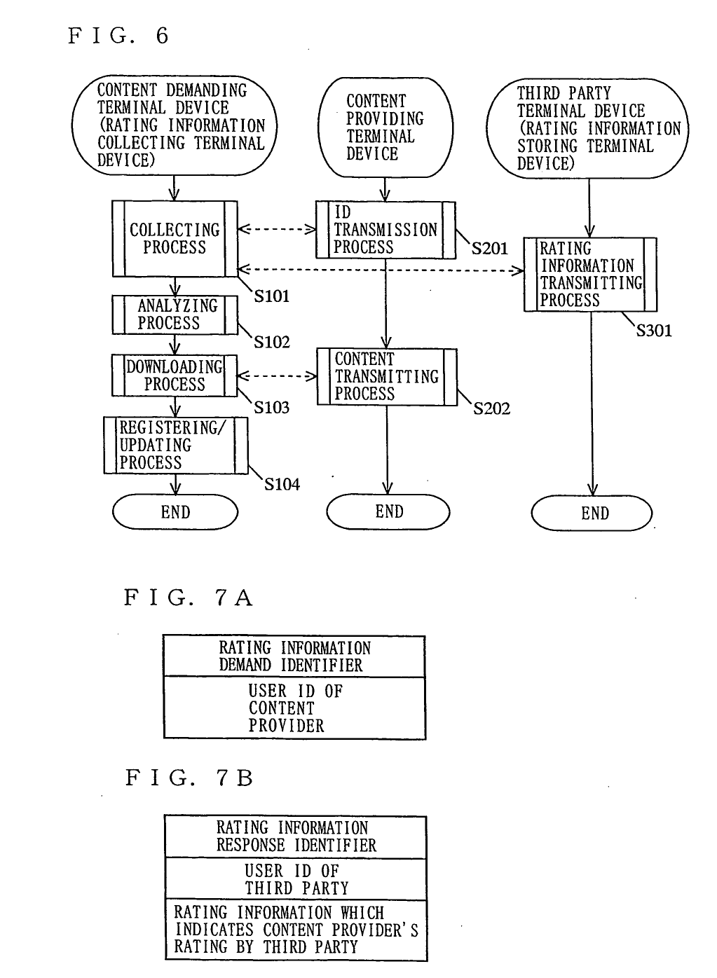

FIG. 6 is a chart illustrating the operation of the entire mutual rating system according to the first embodiment of the present invention. Referring to FIG. 6, the operation of the entire mutual rating system is described below. In the case where the user wishes to download content, the user uses his/her own user terminal device 1 (referred below to as the “content demanding terminal device).

First, the content demanding terminal device performs a collecting process to obtain the user ID of the content provider from the content providing terminal device, and then collects the rating information related to the content provider from the third party terminal devices (step S101: “COLLECTING PROCESS”).

In response to a demand to transmit the user ID of the content provider, which is transmitted by the content demanding terminal device, the content providing terminal device transmits the user ID of the content provider stored therein to the content demanding terminal device (step S201: “ID TRANSMISSION PROCESS”).

In response to a demand to transmit the rating information related to the content provider, which is transmitted by the content demanding terminal device, the third party terminal devices transmit the rating information related to the content provider stored therein to the content demanding terminal device (step S301: “RATING INFORMATION TRANSMISSION PROCESS”).

After the completion of the collecting process, the content demanding terminal device analyzes the collected rating information and notifies the user of the rating for the content provider (step S102: “ANALYZING PROCESS”). Upon being notified of the rating for the content provider, the user determines whether to download his/her desired content from the content provider terminal device, and inputs a determination result to the content demanding terminal device. In accordance with the determination result; the content demanding terminal device determines whether to perform content download. When it is determined to perform the content download, the content demanding terminal device demands the content providing terminal device to transmit the user's desired content (step S103: “DOWNLOADING PROCESS”).

In response to the content transmission demand from the content demanding terminal device, the content providing terminal device transmits the user's desired content to the content demanding terminal device (step S202: “CONTENT TRANSMISSION PROCESS”).

Lastly, the content demanding terminal device causes the user to input the rating and reliability of the content provider, and registers or updates the rating information and the reliability information (step S104: “REGISTERING/UPDATING PROCESS”), thereby completing the procedure of downloading the user's desired content.

In the mutual rating system, in the case where the content demanding terminal device collects the rating information related to the content provider from the third party terminal devices, the content demanding terminal device broadcasts transmission of a rating information demand message to other user terminal devices 1 on the network. FIG. 7A is an exemplary structure of the rating information demand message. As illustrated in FIG. 7A, the rating information demand message contains: a rating information demand identifier by which the message is recognized as the rating information demand message; and the user ID of the content provider.

When a third party terminal device receives the rating information demand message from the content demanding terminal device, the third party terminal device responds to the message by returning a rating information response message which contains rating information related to a designated content provider. FIG. 7B is an exemplary structure of the rating information response message. As illustrated in FIG. 7B, the rating information response message contains: a rating information response identifier by which the message is recognized as the rating information response message; the user ID of the third party who provides the rating information; and the rating information which indicates a content provider's rating by the third party.

Hereinbelow, the operation of each type of terminal devices is described in more detail.

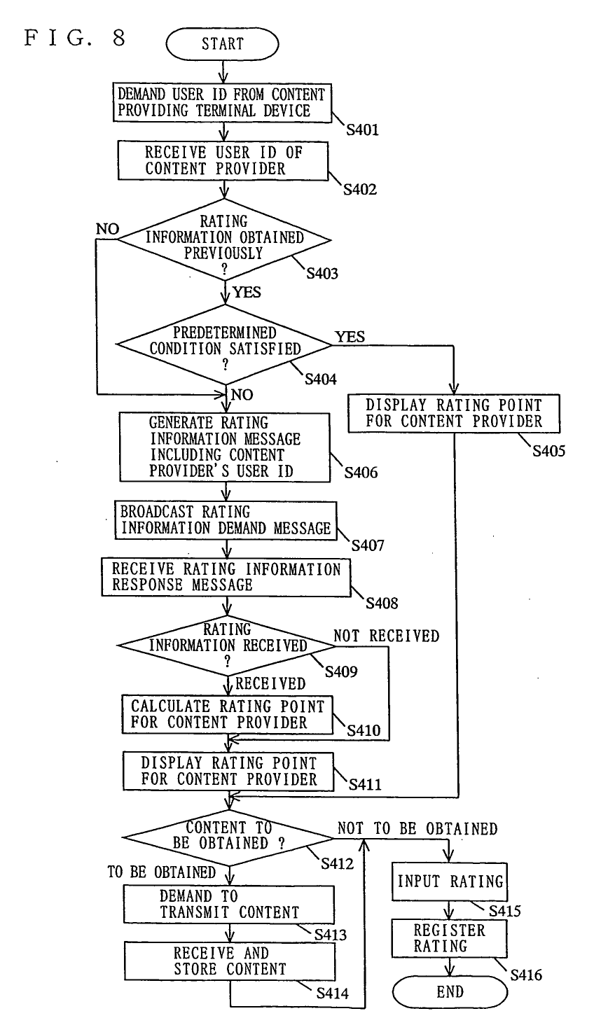

FIG. 8 is a flowchart illustrating the operation of the content demanding terminal device (rating information collecting terminal device). Referring to FIG. 8, the operation of the content demanding terminal device is described below.

Firstly, the rating information collection message generating section 112 of the content demanding terminal device demands a content providing terminal device to transmit the user ID of the content provider (step S401). Then, the rating information collection message generating section 112 receives the user ID of the content provider from the content providing terminal device via the transmitting/receiving section 102 (step S402).

Next, the rating information collection message generating section 112 refers to the rating information stored in the storing section 103 to determine whether the rating information related to the content provider has been obtained previously (step S403). If the rating information has never been obtained, the rating information collection message generating section 112 proceeds to step S406. On the other hand, if the rating information has 32. been obtained previously, the rating information collection message generating section 112 determines whether a predetermined condition is satisfied (step S404).

Here, the predetermined condition is used for determining whether to obtained new rating information. For example, a conceivable condition may be such that “the last update of the rating information stored in the storing section 103 was within. a prescribed time period from the current time”. If the last update of the rating information was within the prescribed time period from the current time, i.e., when the rating information is new, the rating information collection message generating section 112 does not obtain the rating information anew. On the other hand, if the last update of the rating information was within the prescribed time period from the current time, i.e., when the rating information is old, the rating information collection message generating section 112 obtains the rating information anew. Note that, when the rating and reliability information registering section 109 stores the rating information into the storing section 103, the last update of the rating information may be stored in the storing section 103 together with the rating information so as to be associated with the user ID. The predetermined condition may be such that “the reliability of the content provider is high”. In such a case, the rating information collection message generating section 112 refers to the reliability information to check the reliability of the content provider. If the reliability is high, the rating information collection message generating section 112 does not obtain the rating information anew. If the reliability is low, the rating information collection message generating section 112 obtains the rating information anew. Note that the predetermined condition is not limited to the above-described conditions, and may be a combination of a plurality of conditions.

If it is determined at step S404 that the predetermined condition is satisfied, the rating information collection message generating section 112 causes the display section 104 to display, as the user's rating information, the rating information stored in the storing section 103 (step S405), and the procedure proceeds to step S412. On the other hand, if it is not determined that the predetermined condition is satisfied, the procedure proceeds to step S406.

At step S406, the rating information collection message generating section 112 generates a rating information demand message including the obtained user ID of the content provider. Then, the rating information collection message generating section 112 broadcasts the rating information demand message to all the third party terminal devices on the network (step S407). Thereafter, the rating information collection message generating section 112 receives rating information response messages from third party terminal devices which have respond to the rating information demand message (step S408). Note that the rating information collection message generating section 112 temporarily stores the received rating information response messages into the storing section 103. The above-described steps S401 through S408 correspond to the collecting process (step S101) shown in FIG. 6.

Next, the rating information analyzing section 110 of the content demanding terminal device refers to all the received rating response messages to determine whether the rating information has been received from any third party terminal device (step S409). If it is not determined that the rating information has been received, the procedure proceeds to step S411. On the other hand, it is determined that the rating information has been received, the rating information analyzing section 110 calculates a final rating point for the content provider by multiplying the received rating information by the value of the reliability of the third party who has provided the rating information (step S410), and the procedure proceeds to step S411.

Specifically, the reliability has a certain weighting coefficient assigned thereto. For example, the reliability “HIGH” has a weighting coefficient of +2, the reliability “MED” has a weighting coefficient of +1, and the reliability “LOW” has a weighting coefficient of 0. The rating information analyzing section 110 detects the reliability of the third party who provided the rating information from the reliability information stored in the storing section 103, and multiplies a rating point for the content provider, which has been provided by the third party, by a weighting coefficient of the reliability of the third party. Such multiplication is performed for each third party who has provided the rating information. Products obtained by such multiplication are summed together, and the sum is divided by the total values of the reliability of all the third parties who have provided the rating information, thereby calculating the final rating point. That is, the rating point for the content provider={Σ(rating points for the content provider provided by third parties×weighting coefficients for the reliability of the third parties)}÷(total amounts of values of the reliability of the third parties). A statistical technique for calculating the rating for the content provider in the above-described manner is referred to as the “weighted average calculating method”, and a value obtained by such a method is referred to as the “weighted average value”.

For example, in the case where the content demanding terminal device obtains rating points “Pₐ” and “P_{b}” for the content provider from two third party terminal devices “A” and “B”, respectively, when in the reliability information stored in the content demanding terminal device, the weighting coefficient of the reliability of the user of the third party terminal device “A” is set at (+2), and the weighting coefficient of the reliability of the user of the third party terminal device “B” is set at (+1), a weighted average value P for the content provider is such that P=(Pₐ×2+P_{b}×1)÷(2+1). For example, when Pₐ=100 and P_{b}=70, P=90. However, in an ordinary calculation of an average value, (100+70)÷2=85. Comparing the value obtained by the ordinary calculation with the weighted average value, i.e., P=90, it is appreciated that in the weighted average calculating method, importance is placed on the rating information provided by third parties having high reliability. The rating information analyzing section 110 of the content demanding terminal device outputs the weighted average value as a rating point for the content provider rated on the network.

At step S411, the rating information analyzing section 110 causes the display section 114 to display the calculated rating point for the content provider. In this case, when it is determined at step S409 that the rating information has not received, the rating information analyzing section 110 refers to whether the storing section 103 has the rating information related to the content provider. If there is the rating information related to the content provider in the storing section 103, the rating information is displayed on the display section 104. Note that in the case where the rating information demand message has to be broadcast since step S403 determines that the rating information related to the content provider is stored in the storing section 103 and step S404 does not determine that the predetermined condition is satisfied, the rating information analyzing section 110 cause the display section 104 to display the rating information stored in the storing section 103 which does not satisfy the predetermined condition. The display section 104 may display old rating information or even the rating information provided by the user having low reliability. In such a case, the rating information analyzing section 110 may cause the display section 104 to display that the rating information is old or the rating information is obtained from the user having low reliability. On the other hand, in the case where the storing section 103 does not have the rating information related to the content provider, the rating information analyzing section 110 causes the display section 104 to display that there is no rating information related to the content provider. The above-described steps S409 through S411 correspond to the analyzing step (step S102) shown in FIG. 6.

Next, the download processing section 111 of the content demanding terminal device inquires of the user of the content demanding terminal device whether to obtain the user's desired content from the content provider (step S412). If the user indicates to obtain the content, the download processing section 111 demands the content provider to transmit the content (step S413). In response to the demand from the download processing section 111, the content provider transmits the content to the download processing section 111. The download processing section 111 receives the content and stores the received content into the storing section 103 (step S414), and the procedure proceeds to step S415.

On the other hand, in the case where the user indicates not to obtain the content at step S412, the download processing section 111 does not obtain the content, and the procedure proceeds to step S415. The above-described steps S412 through S414 correspond to the downloading process (step S103) shown in FIG. 6.

At step S415, the rating and reliability information registering section 109 causes the display section 104 to display the rating input screen and the reliability input screen, thereby prompting the user to input the rating point and reliability of the content provider. Then, the rating and reliability information registering section 109 stores into the storing section 103 the inputted rating point and reliability, as the rating information and reliability information in a predetermined format (see FIG. 3), (step S416). In the case where the rating information and reliability information related to the content provider have already been stored in the storing section 103 before step S416, the rating and reliability information registering section 109 updates the rating information using a statistical technique (e.g., using an average value of the previous and current rating information) at step S416. The above-described steps S415 and S416 correspond to the registering/updating process (step S104) shown in FIG. 6.

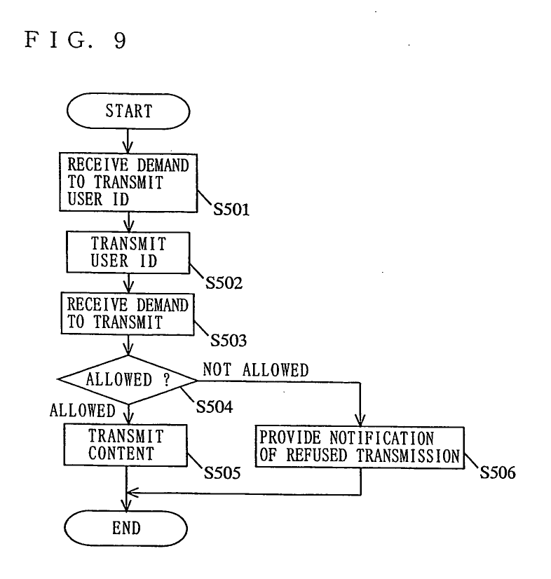

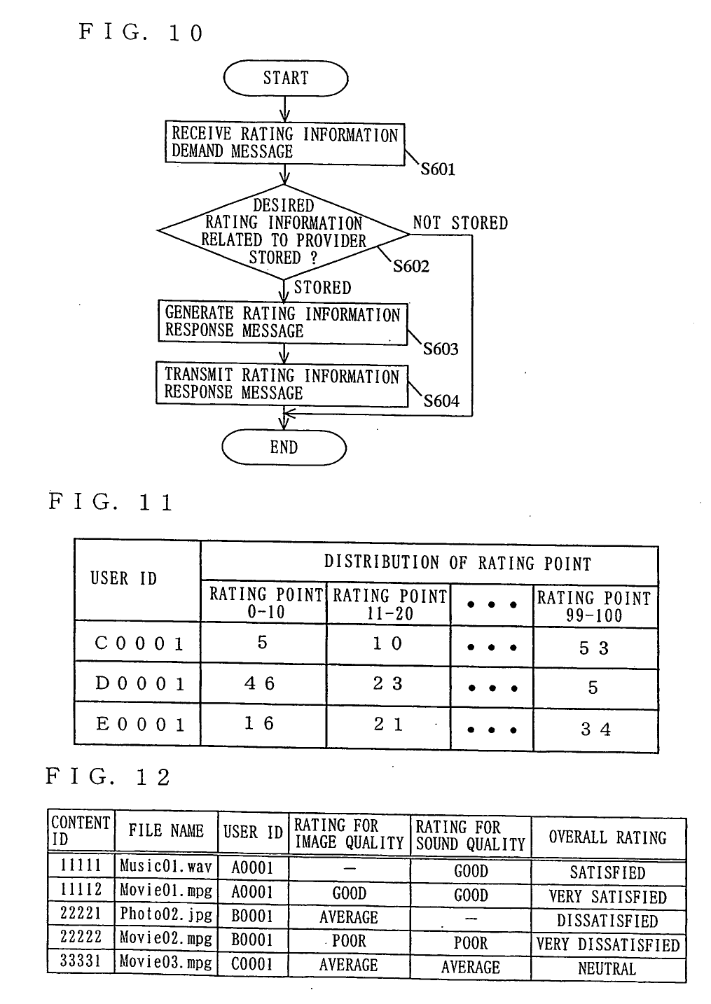

FIG. 9 is a flowchart illustrating the operation of the content providing terminal device. Referring to FIG. 9, the operation of the content providing terminal device is described below.

Firstly, the ID transmission processing section 106 of the content providing terminal device receives a demand to transmit the user. ID of the content provider from the content demanding terminal device (step S501). Then, the ID transmission processing section 106 reads the user ID of the content provider from the storing section 103, and transmits the user ID to the content demanding terminal device via the transmitting/receiving section 102 (step S502). The above-described steps S501 and 502 correspond to the ID transmission process (step S201) shown in FIG. 6.

Next, the content transmission processing section 107 of the content providing terminal device receives a demand to transmit content from the content demanding terminal device (step S503). Then, the content transmission processing section 107 determines whether to allow the transmission of the content (step S504). The determination may be made based on the content provider's instruction or may be automatically made based on a history of previous communication. In the case of allowing the transmission, the content transmission processing section 107 reads the demanded content from the storing section 103, and transmits the content to the content demanding terminal device (step S505). On the other hand, in the case of not allowing the transmission of the content, the content transmission processing section 107 transmits to the content demanding terminal device a message that the transmission of the content is refused (step S506). The above-described steps S503 through S506 correspond to the content transmission process (step S202) shown in FIG. 6.

FIG. 10 is a flowchart illustrating the operation of the third party terminal device (the rating information storing terminal device). Referring to FIG. 10, the operation of the third party terminal device is described below.

Firstly, the rating information collection message responding section 108 of the third party terminal device receives a rating information demand message from the content demanding terminal device (step S601).

Next, the rating information collection message responding section 108 refers to the user ID of the content provider contained in the rating information demand message and determines whether rating information related to the content provider is stored in the storing section 103 (step S602) In the case where no rating information related to the content provider is stored, the third party terminal device terminates the procedure.

On the other hand, in the case where the rating information related to the content provider is stored, the rating information collection message responding section 108 generates a rating information response message (see FIG. 7B) based on the rating information related to the content provider and the user ID of the third party user (step S603). Then, the rating information collection message responding section 108 transmits the generated rating information response message to the content demanding terminal device (step S604). The above-described steps S601 through S604 correspond to the rating information transmission process (step S301) shown in FIG. 6.

As described above, in the mutual rating system according to the first embodiment, each user on the network rates the content provider, and stores a rating result into his/her own terminal device. Upon demand from another terminal device, the user returns rating information of the content provider. In this manner, each user terminal device on the network stores the rating information, and therefore it is possible to rate the content provider on the network without using a server.

Further, a rating point for the content provider is calculated by multiplying rating points transmitted from other user terminal devices by a weighting coefficient related to the reliability of the content provider, and therefore it is possible to cause calculation of the rating point for the content provider to be less susceptible to the influence of rating information transmitted from unreliable users who maliciously rate a specific user. Accordingly, it is possible to provide a mutual rating system capable of avoiding conspiracy of the users who maliciously rate the specific user. Moreover, importance is placed on rating information from highly reliable users when calculating the rating point of the content provider, and therefore it is possible to obtain reliable rating information.

Furthermore, each user terminal device always displays the rating input screen and the reliability input screen after the completion of content downloading, and therefore it is possible to avoid the situation where a rating for the content provider is not inputted.

Note that in the first embodiment, when the content demanding terminal device broadcasts a rating information demand message, the rating information collection message section 112 may add to the rating information demand message a hop count, i.e., a maximum number of routers through which the rating information demand message is able to pass, or a life time of the message on the network, for example. In such a case, the added hop count or life time may be reduced by each router on the network through which the rating information demand message passes, so that the rating information demand message is discarded when the hop count or the life time is reduced to zero. This prevents the broadcast rating information demand message from being present on the network for an unnecessarily long period of time.

Further still, the user terminal device may transmit the rating information demand message to specific user terminal devices rather than broadcast the rating information demand message. For example, each user terminal device may transmit the rating information demand message only to the group of user terminal devices in which the user terminal device belongs. Alternatively, each user terminal device may refer to a communication history to transmit the rating information demand message only to a predetermined number of user terminal devices with which the user terminal device had communication recently.

In the above-described steps S409 and S410, in order to calculate a final rating point, the presence or absence of the rating information is determined referring to the rating information response message temporarily stored in the storing section 103. However, calculation of the final rating point is not limited to such a manner. For example, the final rating point may be calculated in such a manner that upon each receipt of the rating information response message transmitted from another user terminal device, the presence or absence of the rating information is determined to obtain a rating point contained in the rating information, and each rating point obtained is weighted with the reliability and sequentially added to other rating points in the obtained order. This allows a mobile telephone having a storage section with a limited storage space to calculate the final rating point. Note that calculation of the final rating point is not limited to such a manner.

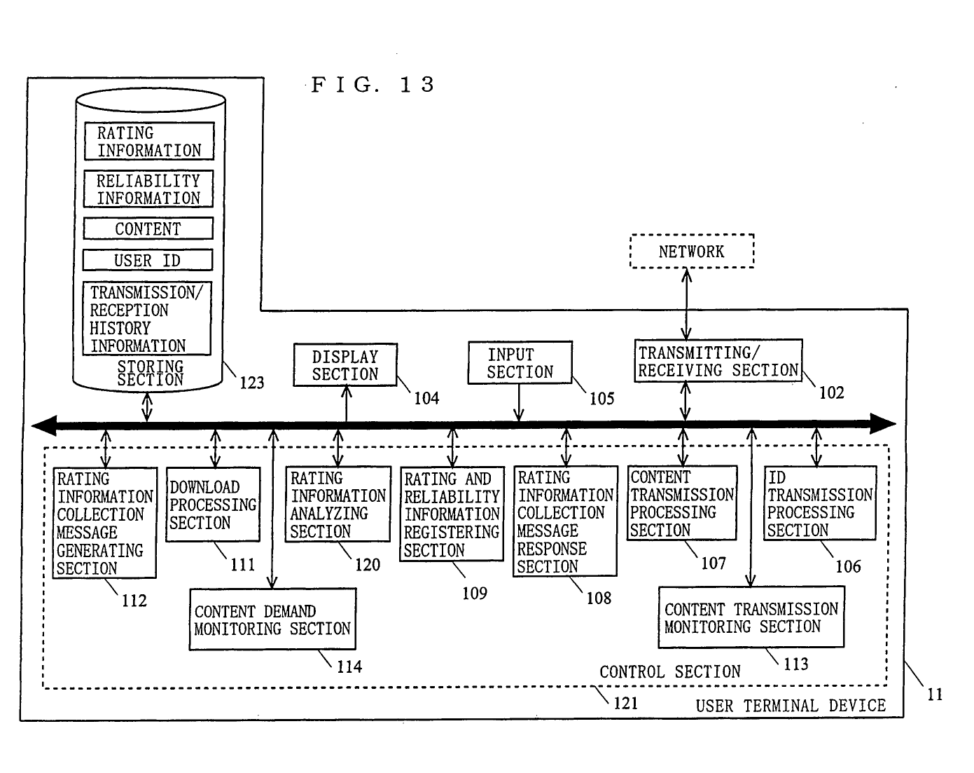

In the first embodiment, as shown in FIG. 3, the rating information is realized as the correspondence between rating points statistically processed for each user. However, representation of the rating information is not limited to such a manner. FIG. 11 is a table illustrating another example of the rating information. As illustrated in FIG. 11, rating points may be grouped into several grades so as to indicate how the rating points awarded to specific users are distributed. In the rating information defined in the example of FIG. 11, the user having user ID “C001” is awarded rating points from 0 to 10 by five users, rating points from 11 to 20 by ten users, and rating points from 99 to 100 by fifty-three users. In the case of using the rating information which indicates the distribution of the rating points in the above-described manner, the rating information analyzing section 110 may cause the display section 104 to display the distribution in the form of a graph, so as to present a rating for a specific user. Alternatively, the distribution may be statistically analyzed to present a rating for a specific user. In addition to the above-described information which indicates the distribution of the rating points, for example, character information generated by another user may be used as the rating information. Note that any type of information can be used as the rating information so long as the information indicates a rating for the user.

As illustrated in FIG. 2, in the first embodiment, the control section 101 for operating the user terminal device is realized by a specialized microprocessor which operates in a manner as described above. However, the control section 101 is not limited to such a microprocessor. For example, the control section 101 may be provided as a general-purpose CPU such that the CPU reads and executes a program, which is installed in the storing section 103 so as to operate in a manner as described above, or the CPU downloads such a program via the network and executes the downloaded program. When the program is executed, the CPU operates in the same manner as shown in FIGS. 8-11. For example, a personal computer, a mobile terminal device, or the like can be used as a user terminal device using such a CPU.

In the first embodiment, each user terminal device has the following functions: a function as a content providing terminal device which provides content (a content providing function, i.e., a function realized by the ID transmission processing section 106 and the content transmission processing section 107); a function as a third party terminal device (a rating information storing terminal device ) which has rating information of content providers and transmits the rating information on demand (a third party function or rating information storing function, i.e., a function realized by the rating information collection message responding section 108); and a function as a content demanding terminal device (a rating information collection terminal device) which collects the rating information and demands transmission of content (a content demanding function, i.e., a function realized by the rating information collection message generating section 112, the downloading section 111, the rating information analyzing section 110, and the rating and reliability information registering section 109). However, each user terminal device may have only one of the content providing function, the third party function, and the content demanding function, or may have a combination of two of the above functions.

Note that it is not necessary to assign a user ID to each user on the network so long as information for uniquely specifying each user of user terminal devices on the network is provided.

In the first embodiment, the user checks the rating point for the content provider to determine whether to download content. However, the download processing section 111 may determine whether to download the content based on a rating point of the content provider calculated by the rating information analyzing section 110. For example, when the rating point is equal to or more than a predetermined threshold value, the download processing section 111 may automatically download the content.

In the first embodiment, the rating information collection message responding section 108 of the third party terminal device determines whether rating information related to a provider of a desired content is stored in the storing section 103 of the same terminal device. However, the rating information collection message responding section 108 may transmit all the rating information and reliability information stored in the storing section 103 without making a decision as described above.

In this case, the rating information analyzing section 110 of the content demanding terminal device may obtain the rating point for the content provider from the transmitted rating information, and further obtain the reliability of users other than the content provider (i.e., third parties), so as to calculate a weighted average value of rating points transmitted from third party terminal devices. This allows the content demanding terminal device to obtain a weighted average for the rating points even if the content demanding terminal device does not have reliability information related to other users. Moreover, the rating information and reliability information can propagate through the network quickly. That is, each terminal device can store the rating information and reliability information related to a great number of terminal devices and contents, and thus improved hit rate can be obtained when searching for such information.

In the first embodiment, the rating information indicates a rating for the content provider itself. The content provider can be rated as to whether it has good-quality content. Accordingly, a rating for content obtained from the content provider or a rating for the content providing terminal device maybe used as the rating information, for example. That is, any kind of rating can be used so long as the rating is related to an object associated with the network. FIG. 12 is a table illustrating an exemplary data structure of the rating information in the case where contents obtained from content providers are rated.

In this case, as shown in FIG. 12, each content has a content ID assigned thereto. A rating for content is registered as the rating information at a time point when reproduction of content having no registered rating is completed. At this point, the user terminal device 1 activates the rating and reliability information registering section 109. The rating and reliability information registering section 109 causes the display section 104 to display a graphical user interface (GUI) for selecting a level of satisfaction with content. Specifically, at the time point when the user terminal device 1 completes content reproduction, the rating and reliability information registering section 109 refers to the rating information stored in the storing section 103 to determine whether rating information related to reproduced content is registered. If it is registered, the rating and reliability information registering section 109 causes the display section 104 to display the GUI and prompts the user to input a rating for the content. When the rating for the content is inputted, the rating and reliability information registering section 109 registers rating information related to the content into the storing section 103 in conformity with the format shown in FIG. 12.

In the example of FIG. 12, ratings for qualities (image or sound qualities) of contents are represented by “GOOD”, “AVERAGE”, and “POOR”. For example, a content having file name “Music01.wav” obtained from the user having user ID “A0001” has content ID “1111”. Since this content is music data, a rating for image quality is not provided, and the sound quality is rated as “GOOD”, while “SATISFIED” is provided as the overall rating. A content having file name “Movie01.mpg” obtained from the user having user ID “A0001” is video data. Accordingly, ratings for image and sound qualities are provided. In this example, the user rated the content as “GOOD” for the image and sound qualities, and “VERY SATISFIED” is provided as the overall rating therefor. Although file names are used for specifying the contents, the contents may be specified by search using a hash method.

Note that qualities of content to be rated are not limited to image and sound qualities. Content can be rated for anything related to its quality.

In the example shown in FIG. 12, a rating (a satisfaction level) for content is selected from among five alternatives, i.e., “VERY SATISFIED”, “SATISFIED”, “NEUTRAL”, “DISSATISFIED”, and “VARY DISSATISFIED”. The alternatives used for rating content are not limited to the five alternatives as described above. Any alternatives can be used so long as degrees of rating for content are clearly provided.

In the case where the content demander wishes to know the rating for a content, the rating information collection message generating section 112 generates a rating information demand message, which includes a content ID instead of the user ID of the content provider included in the rating information demand message as shown in FIG. 7A, and broadcasts the generated rating information demand message to other user terminal devices (i.e., third party terminal devices) on the network. In the case where a third party terminal device, which has received the rating information demand message, has rating information related to a desired content, the third party terminal device stores the rating information into a rating information response message, and returns the message to the content demanding terminal device. In this manner, the content demanding terminal device collects the rating information related to the desired content, and the rating information analyzing section 110 of the content demanding terminal device analyzes the collected rating information using a statistical technique. As described above, there are various conceivable statistical techniques by which a weighted average for rating points is provided or the total number of users is calculated for each alternative.

In this manner, by rating contents in a manner similar to rating of the users, it is made possible to check the rating for the desired content. Accordingly, in the first embodiment, objects to be rated are not limited to the content provider and the desired content, and various items can be used as the objects to be rated.

### Second Embodiment

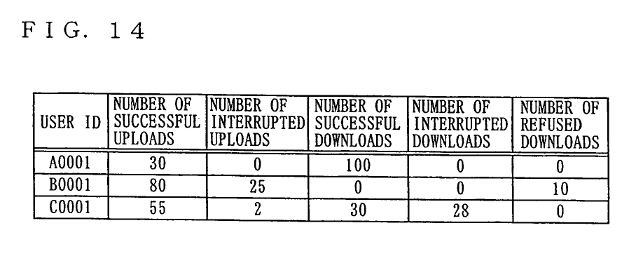

The entire structure of a mutual rating system according to a second embodiment of the present invention is similar to that of the mutual rating system according to the first embodiment as shown in FIG. 1, and therefore detailed description thereof is not provided here. FIG. 13 is a diagram illustrating the structure of a user terminal device 11 according to the second embodiment. In FIG. 13, elements having functions similar to those of elements of the user terminal device 1 shown in FIG. 2 are denoted by similar reference numerals, and description thereof is omitted.

In FIG. 13, the user terminal device 11 includes: a control section 121; a transmitting/receiving section 102; a storing section 123; a display section 104; and an input section 105. The control section 121 includes an ID transmission processing section 106; a content transmission processing section 107; a rating information collection message responding section 108; a rating and reliability information registering section 109; a rating information analyzing section 120; a download processing section 111; a rating information collection message generating section 112; a content transmission monitoring section 113; and a content demand monitoring section 114.

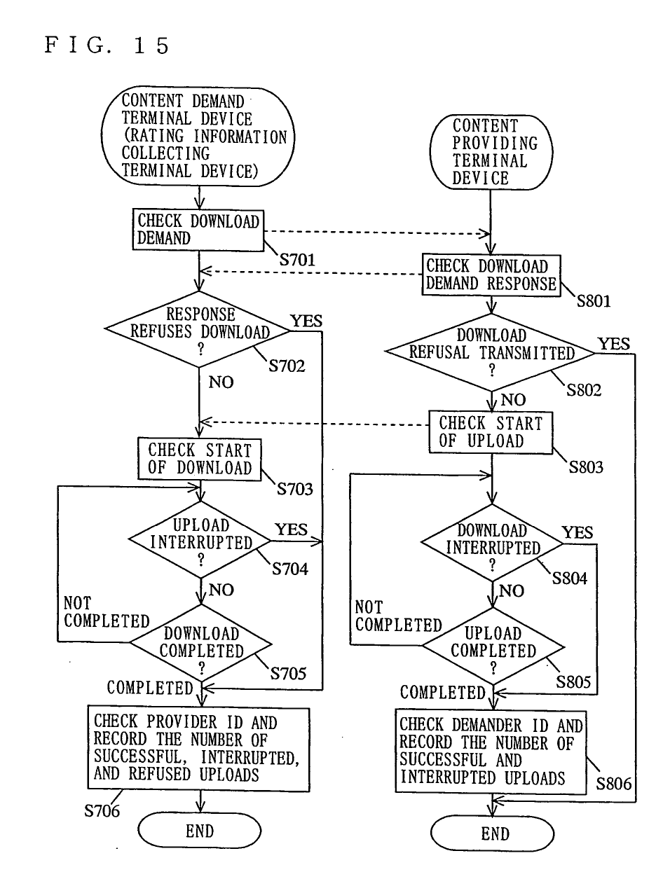

The storing section 123 has transmission/reception history information stored therein. In the transmission/reception history information, history as to whether exchange processes have succeeded is stored for each user ID with respect to the cases where content is downloaded from another user terminal device and content is uploaded to another user terminal device. FIG. 14 is a table illustrating an exemplary data structure of the transmission/reception history information. As shown in FIG. 14, as the transmission/reception history information, the number of successful uploads, the number of interrupted uploads, the number of successful downloads, the number of interrupted downloads, and the number of refused downloads are registered for each user ID.

The number of successful uploads refers to the number of times content upload from the content providing terminal device to the content demanding terminal device has been normally completed without being interrupted. The number of interrupted uploads refers to the number of times content upload from the content providing terminal device to the content demanding terminal device has been interrupted. The number of successful downloads refers to the number of times a desired content has been downloaded from the content providing terminal device to the content demanding terminal device without being interrupted. The number of interrupted downloads refers to the number of times content download from the content providing terminal device to the content demanding terminal device has been interrupted. The number of refused downloads refers to the number of times content download demand from the content demanding terminal device has been refused by the content providing terminal device.

In the example of FIG. 14, with respect to communication with the user terminal device owned by the user having user ID “A0001” (hereinafter, referred to as the “A0001” terminal device), there are thirty successful uploads to the “A0001” terminal device, and no uploads are interrupted. Also, there are a hundred successful downloads from the “A0001” terminal device, and no downloads are interrupted. Moreover, no downloads are refused by the “A0001” terminal device.

Once the content transmission processing section 107 starts uploading of desired content in response to a demand from the content providing terminal device, the content transmission monitoring section 113 starts monitoring of the uploading and record to the storing section 123 the number of successful and interrupted uploads as the transmission/reception history information. Note that in the case of recording the transmission/reception history information, when the user ID of the content demander is not registered in the storing section 123, the content transmission monitoring section 113 obtains a new space for the user ID of the content demander and writes the number of successful and interrupted uploads into the new space. Alternatively, when the user ID of the content demander has been registered, the content transmission monitoring section 113 adds the number of successful and interrupted uploads to corresponding fields, thereby updating the transmission/reception history information.

Once the download processing section 111 starts downloading of desired content from the content providing terminal device, the content demand monitoring section 114 starts monitoring of the downloading and record to the storing section 123 the number of successes and failures as the transmission/reception history information. Note that in the case of writing the transmission/reception history information, when the user ID of the content provider is not registered in the storing section 123, the content demand monitoring section 114 obtains a new space for the user ID of the content provider and writes the number of successes and failures into the new space. Alternatively, when the user ID of the content provider has been registered, the content demand monitoring section 114 adds the number of successes and failures to corresponding fields, thereby updating the transmission/reception history information.

As described in the first embodiment, when collecting information related to the content provider from third party terminal devices, the rating information analyzing section 120 collects from the third party terminal devices the transmission/reception history information related to the content provider as well as rating information. The rating information analyzing section 120 analyzes the rating information based on the collected transmission/reception history information, for example, by aggregating the number of successes and failures of content exchange by the content provider. An analyze result is displayed on the display section 104 so as to allow the user to determine whether to download content.

FIG. 15 illustrate flowcharts showing the operation of the content demand monitoring section 114 of the content demanding terminal device (the rating information collecting terminal device) according to the second embodiment and the operation of the content transmission monitoring section 113 of the content providing terminal device according to the second embodiment. Referring to FIG. 15, the operations of the content demand monitoring section 114 and the content transmission monitoring section 113 are described below.

Firstly, the content demand monitoring section 114 checks whether the download processing section 111 has provided the content providing terminal device with a demand to transmit content (step S701).

If the content demanding terminal device has demanded transmission of content, the content transmission monitoring section 113 of the content providing terminal device checks whether the content transmission section 107 provides the content demanding terminal device with a response to the demand to transmit content (step S801). Then, the content transmission monitoring section 113 determines whether the response refuses download (step S802). If the download has been refused, the content transmission monitoring section 113 terminates the procedure. On the other hand, if the download has not been refused, the content transmission monitoring section 113 check whether the content transmission processing section 107 has started upload of content (step S803).

Next, the content transmission monitoring section 113 determines whether the download has been unilaterally interrupted by the content demanding terminal device (step S804). Here, the interruption is intended to mean that disconnection from the content demanding terminal device has continued for a prescribed time period or reconnection has not succeeded within a prescribed number of attempts at connection. If the download has been interrupted, the procedures proceeds to step S806, where the content transmission monitoring section 113 checks the user ID of the content provider and rewrites the number of interrupted uploads of the transmission/reception history information stored in the storing section 123 (in the case where the user ID of the content demander is not registered, transmission/reception history information related to the user ID is generated anew). On the other hand, if the download has not been interrupted, the content transmission monitoring section 113 determines whether content upload has been completed (step S805). If the content upload has not been completed, the content transmission monitoring section 113 repeats the process of step S804. On the other hand, if the content upload has been completed, the content transmission monitoring section 113 checks the user ID of the content demander, and rewrites the number of successful uploads of the transmission/reception history information stored in the storing section 123 (step S806), thereby terminating the procedure.

Back to the description of the operation of the content providing terminal. Following step S701, the content demand monitoring section 114 determines the response from the content providing terminal refuses the download (step S702). IF the download has been refused, the procedure proceeds to step S706, where the content demand monitoring section 114 checks the user ID of the content provider and rewrites the number of refused downloads of the transmission/reception history information stored in the storing section 123.

On the other hand, if the download has not been refused, the content demand monitoring section 114 determines whether the downloading section has started download (step S703). Then, the content demand monitoring section 114 determines whether content upload has been unilaterally interrupted by the content providing terminal device (step S704). If the upload has been interrupted, the procedures proceeds to step S706, where the content demand monitoring section 114 checks the user ID of the content provider and rewrites the number of interrupted downloads of the transmission/reception history information stored in the storing section 123.

On the other hand, if the upload has not been interrupted, the content demand monitoring section 114 determines whether the download has been completed (step S705). If the download has not been completed, the content demand monitoring section 114 repeats the process of step S704. On the other hand, if the download has been completed, the content demand monitoring section 114 checks the user ID of the content provider, and rewrites the number of successful downloads of the transmission/reception history information stored in the storing section 123 (step S706), thereby terminating the procedure.

Described next is the use of the transmission/reception information recorded in the above-described manner. The rating information analyzing section 120 causes the display section 104 to display, based on transmission/reception history information related to the content provider received from the third providers, the number of attempts at download from the content provider and the number of successes and failures in the attempts, thereby allowing the user to determine whether to download content from the content provider.

As described above, in the second embodiment, the user is able to check the number of successes and failures of content exchange of the exchanging partner, and therefore it is possible to know, for example, that the exchanging partner has a tendency of only performing downloads, a good tendency of not causing interruption, or a bad tendency.

Note that the content providing terminal device can also handle the transmission/reception history information. Specifically, the content transmission processing section 107 of the content providing terminal device simultaneously demands third party terminals to transmit transmission/reception history information related to a content demander, and collects the transmission/reception history information related to the content demander. Then, the content transmission processing section 107 obtains, based on the collected transmission/reception history information, information which indicates the number of attempts at upload to the content demander and the number of successes and failures in the attempts. Thereafter, the display section 104 is caused to display the obtained information, thereby allowing the user to determine whether to upload content to the content demander. Alternatively, whether to upload content to the content demander may be automatically determined by comparing the obtained information with a prescribed threshold value.

In the second embodiment, the rating information analyzing section 120 of the content demanding terminal device causes the display section 104 to display the aggregated number of successes and failures of content exchange. However, the present invention is not limited to this, and the rating information analyzing section 120 may obtain numerical values, such as percentages of success, interruption, and failure of content exchange, and cause the display section 104 to display the numerical values so as to allow the user to know the tendency of the exchanging partner to exchange content with other users. Similarly, the rating information analyzing section 120 of the content providing terminal device can operate in a manner as described above.

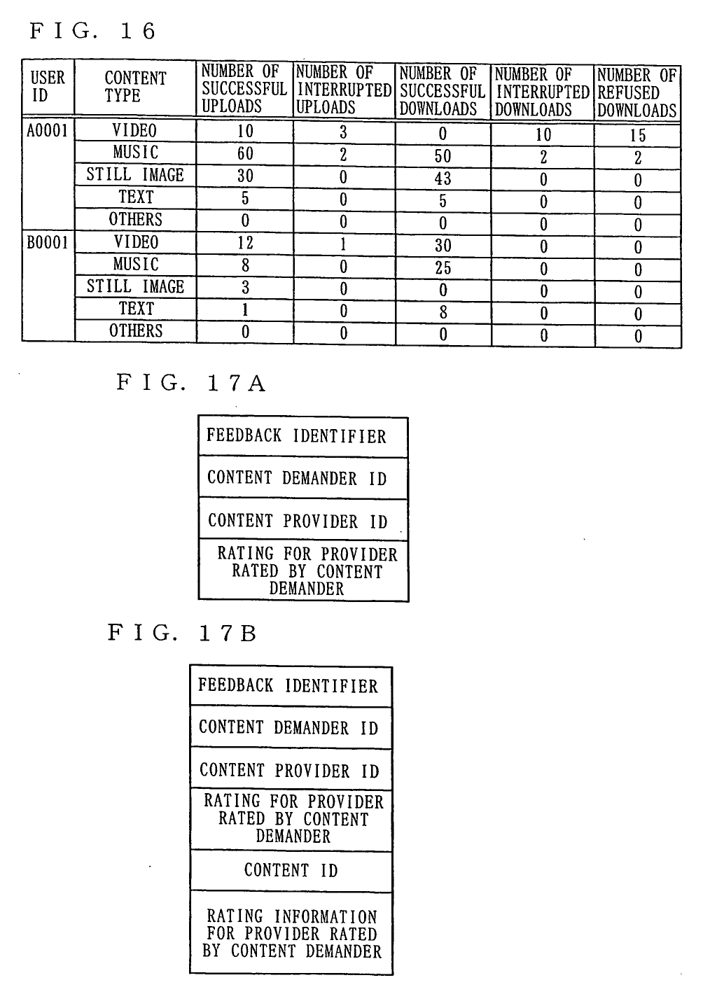

In the above-described transmission/reception history information, the number of successes and failures of content exchange is associated with each user. However, the number of successes and failures of content exchange may be associated with each of content type, such as video, music, still image, and text. FIG. 16 is a table illustrating exemplary transmission/reception history information in which the number of successes and failures of content exchange is associated with content types. In the transmission/reception history information of FIG. 16, the number of successes and failures of content exchange is associated with video content, music content, still image content, text content, and other content.

For example, the user terminal device 1, which has the transmission/reception history information of FIG. 16 stored in its storing section 123, has exchanged content with the user having user ID “A0001” and the user having user ID “B0001”. Download of video content from the user having user ID “A0001” has never succeeded, and there are ten interrupted downloads and fifteen refused downloads. Upload of video content to the user having user ID “A0001” has succeeded ten times, and there are three interrupted downloads.

From the transmission/reception history information, it is appreciated that the user having user ID “A0001” is not willing to upload video content. Accordingly, it is recommended to avoid downloading video content from this user.

The rating information analyzing section 120 collects the transmission/reception history information as described above from the third party terminals in order to display, for example, the aggregated number of successes and failures of content exchange or the success to failure ratio for content exchange, thereby allowing the user to determine whether to exchange content. Alternatively, in the case where content exchange is successful in a ratio equal to or more than a prescribed threshold ratio, the rating information analyzing section 120 may cause the user terminal device to automatically perform content exchange.

As described above, when the number of successes and failures of content exchange is associated with content types, the user is able to know the tendency of the exchanging partner to exchange content with other users with respect to content types.

### Third Embodiment

A third embodiment of the present invention is different from the first and second embodiments in that after the content demander rates the content provider, the rating information is broadcast to other user terminal devices 1 on the network. The stricture of each user terminal device 1 according to the third embodiment is similar to the user terminal device 1 according to the first embodiment as shown in FIG. 2, and therefore detailed description thereof is not provided here. In the third embodiment, the rating and reliability information registering section 109 causes the user to register rating information, and thereafter the rating information is broadcast as feedback information to other user terminal devices on the network.

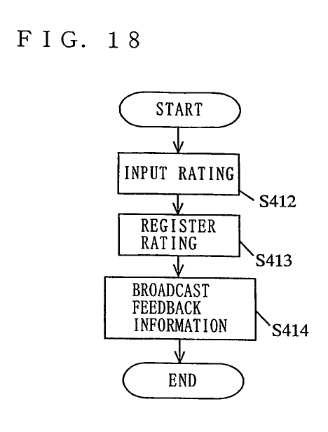

FIGS. 17A and 17B illustrate exemplary data structures of feedback information transmitted by the rating and reliability information registering section 109. Specifically, in FIG. 17A, an exemplary data structure of feedback information containing ratings for a content provider is shown. The feedback information shown in FIG. 17A contains: an identifier by which the information is recognized as the feedback information; user IDs of content demanders; user IDs of content providers; and rating points for the content providers rated by the content demanders.

In FIG. 17B, an exemplary data structure of feedback information additionally containing ratings for content provided by the content providers is shown. In addition to the contents of the feedback information shown in FIG. 17A, the feedback information shown in FIG. 17B further contains content IDs, and rating points for content rated by the content demanders.

FIG. 18 is a flowchart illustrating the operation of the rating and reliability information registering section 109. Described below is the operation of the rating and reliability information registering section 109 in the case of using the feedback information containing rating points for the content providers. In FIG. 19, the same step numbers as those shown in FIG. 8 are used in order to show the correspondence between FIGS. 8 and 19.

Firstly, the rating and reliability information registering section 109 causes the user to input a rating for a content provider (step S412). Then, the rating and reliability information registering section 109 generates rating information based on the inputted rating and stores the rating information into the storing section 110 (step S413). Further, the rating and reliability information registering section 109 generates feedback information based on the inputted rating and broadcast the feedback information to other user terminal devices on the network (step S414), thereby completing the procedure. Regarding the feedback information as shown in FIG. 17B which contains ratings for content, the rating and reliability information registering section 109 broadcast such feedback information to other user terminal devices on the network after the completion of reproduction and rating of content. Note that in the case of broadcasting the feedback information as described above, for example, a hop count, i.e., a maximum number of routers through which the feedback information is able to pass, or a life time of the information on the network may be added to the feedback information. In such a case, the added hop count or life time may be reduced by each router on the network through which the feedback information passes, so that the feedback information is discarded when the hop count or the life time is reduced to zero. Further, the feedback information as described above may be transmitted only to online user terminal devices 1.

The rating information analyzing section 110 of each user terminal device 1 on the network which has received the feedback information refers to the feedback information for the user ID of a content provider and determines whether rating information related to the user ID of the content provider is stored in the storing section 103 of the terminal device 1. If such rating information is stored, the rating information analyzing section 110 uses a statistic technique to calculate a new rating point for the content provider based on the rating information related to the content provider contained in the feedback information and the rating information related to the content provider stored in the storing section 103 of the terminal device 1. As in the case of the first and second embodiments, the statistic technique to be used here is a weighted average calculating method. The rating information analyzing section 120 causes the storing section 103 to store the calculated rating point as new rating information. On the other hand, if the rating information related to the user ID of the content provider is not stored in the storing section 103, the rating information analyzing section 110 performs no processing.

As described above, in the third embodiment, ratings for the content provider and content are broadcast to other user terminal devices on the network. Accordingly, each user terminal device on the network is able to obtain ratings for users on the network without through the use of the server.

Further, by feeding back the rating information to other user terminal devices on the network, it is made possible to widely propagate the rating information, which dynamically changes on the network. Accordingly, the reliability of the rating information held by the online user terminal devices is enhanced, leading to enhancement of the reliability of the entire network.

Furthermore, since the feedback information is broadcast, latest rating information can be provided to a user terminal device newly connected to the network.

In the third embodiment, although the feedback information is transmitted to all the user terminal devices on the network, the feedback information may be transmitted to a specific user terminal device or a specific group of user terminal devices.

Alternatively, the feedback information may be transmitted only to online user terminal devices.

Alternatively still, the feedback information may be transmitted only to user terminal devices having returned rating information, but not to user terminal devices having returned no rating information. In this case, the user terminal device, which transmits the feedback information, may store a history indicating which user terminal devices have returned rating information before transmitting the feedback information, and may transmit the feedback information based on the stored history.

Alternatively still, the user terminal device, which transmits the feedback information, may transmit the feedback information only to user terminal devices having returned rating information considerably different from that stored in the user terminal device. In this case, the user terminal device, which transmits the feedback information, may store a history indicating which user terminal devices have returned what rating information before transmitting the feedback information, and may transmit the feedback information based on the stored history. Note that the feedback information may be transmitted to user terminal devices having returned rating information different from that stored in the user terminal device even if the difference is not considerable.

Note that upon receipt of the feedback information, each user terminal device may update rating information stored therein and may transmit the received feedback information or the updated rating information to other user terminal devices. In this case, the received feedback information or the updated rating information may be broadcast to all the user terminal devices on the network or may be transmitted to a specific user terminal device, other user terminal devices in the same group, or a prescribed number of user terminal devices with which the user terminal device has communicated recently. The feedback information is exchanged between user terminal devices on the network in a manner as described above, so that each of the rating information and the reliability information is updated so as to indicate a broad consensus among users across the network. Consequently, even if the rating information is not exchanged between the user terminal devices on the network, each user terminal device accumulates rating information in which each object on the network is validly rated, thereby providing a network in which objects are mutually rated.

### INDUSTRIAL APPLICABILITY

The present invention provides a mutual rating system and a terminal device and program for use in the same system which enable terminal devices to mutually check ratings for objects without using a central server, and are advantageous when used in a system for rating content, users, and terminal devices, for example.

1. A mutual rating system for rating an object associated with a network, comprising:
a plurality of rating information storing terminal devices connected to the network, each rating information storing terminal device having stored therein rating information related to an object previously rated by the user; and
one or more rating information collecting terminal devices for collecting rating information related to a desired object from one or more online rating information storing terminal devices,
wherein each rating information collecting terminal device includes a rating analyzing section operable to analyze the rating information collected from said one or more rating information storing terminal devices to obtain a rating for the desired object.

2. The mutual rating system according to claim 1, further comprising one or more content providing terminal devices each having content stored therein and transmitting the content on demand,
wherein each rating information collecting terminal device further includes a content demanding section operable to demand a content providing terminal device having the desired content stored therein to transmit the desired content.

3. The mutual rating system according to claim 2,
wherein each rating information storing terminal device further includes a download history storing section having stored therein a communication history of content downloaded from said one or more content providing terminal devices,
wherein each rating information collecting terminal device further includes a communication history collecting section operable to, when demanding said one or more content providing terminal devices to transmit the desired content, collect a communication history related to said one or more content providing terminal devices stored in online rating information storing terminal devices, and
wherein the rating analyzing section analyzes the communication history collected by the communication history collecting section to determine whether to download the desired content from a content providing terminal device having the desired content stored therein.

4. The mutual rating system according to claim 3,
wherein the download history storing section stores the communication history so as to be associated with content types, and
wherein the rating analyzing section refers to the content types to determine whether to demand content transmission.

5. The mutual rating system according to claim 2,
wherein said one or more content providing terminal devices each include an upload history storing section into which a communication history of content uploaded to the rating information collecting terminal devices is stored, and
wherein said one or more content providing terminal devices each determine whether to perform content upload based on the communication history stored inthe upload history storing section.

6. The mutual rating system according to claim 5,
wherein the upload history storing section stores the communication history so as to be associated with content types, and
wherein said one or more content providing terminal devices each refer to the content types to determine whether to perform the content upload.

7. The mutual rating system according to claim 2,
wherein each rating information collecting terminal device further includes:
a rating information input section operable to cause, after the completion of download of the desired content, the user to input rating information related to said one or more content providing terminals and/or content providers of the desired content, and to store the inputted rating information; and
a rating information feeding back section operable to feedback the rating information stored by the rating information input section to other rating information collecting terminal devices and rating information storing terminal devices on the network, and
wherein each rating information storing terminal device further includes a fed back rating information storing section which uses a prescribed technique to analyze the rating information fed back from the rating information feeding back section, and stores the analyzed rating information.

8. The mutual rating system according to claim 1,
wherein each rating information collecting terminal device further includes a rating information storing section having stored therein the rating information related to the objects previously rated by the user, and
wherein each rating information storing terminal device further includes:
a rating information collecting section operable to collect the rating information related to the desired object from one or more online rating information collecting terminal devices; and
a collected rating information analyzing section operable to analyze the rating information collected by the rating information collecting section to obtain a rating for the desired object.

9. A rating information collecting terminal device for obtaining rating information related to an object associated with a network to which a plurality of rating information storing terminal devices are connected, each rating information storing terminal device having stored therein rating information related to objects previously rated by the user, the rating information collecting terminal device comprising:
a rating information collecting section operable to collect rating information related to a desired object from one or more online rating information storing terminal devices; and
a rating analyzing section operable to analyze the rating information collected by the rating information collecting section to obtain a rating for the desired object.

10. The rating information collecting terminal device according to claim 9, wherein the rating information collecting section collects the rating information from said one or more rating information storing terminal devices only when a prescribed condition is satisfied.

11. The rating information collecting terminal device according to claim 9, wherein the rating information collecting section collects the rating information from all the online rating information storing terminal devices.

12. The rating information collecting terminal device according to claim 9, wherein the rating information collecting section collects the rating information from a specific rating information storing terminal.

13. The rating information collecting terminal device according to claim 9, wherein the object is a user on the network, an online terminal device, or content stored in the online terminal device.

14. The rating information collecting terminal device according to claim 9, further comprising a reliability information storing section having stored therein reliability information which indicates reliabilities of the rating information storing terminal devices and/or rating information providers present on the network, wherein when obtaining a rating result, the rating information analyzing section refers to the reliability information stored in the reliability information storing section and prioritizes rating information provided by highly reliable rating information storing terminal devices and/or highly reliable rating information providers.

15. The rating information collecting terminal device according to claim 14, wherein the rating information analyzing section uses weighting coefficients assigned as the reliabilities to the reliability information to obtain a weighted average, and thereby to obtain the rating result.

16. The rating information collecting terminal device according to claim 9, further comprising a content demanding section operable to demand transmission of desired content from one or more content providing terminal devices connected to the network, each content providing terminal device having content stored therein and transmitting the content on demand.

17. The rating information collecting terminal device according to claim 16, wherein the content demanding section automatically demands content transmission from said one or more content providing terminal devices based on a rating result obtained by the rating analyzing section.

18. The rating information collecting terminal device according to claim 16, further comprising a download history storing section to which a communication history of content downloaded from said one or more content providing terminal devices, wherein the content demanding section determines whether to demand content transmission based on the communication history stored in the download history storing section.

19. The rating information collecting terminal device according to claim 18,
wherein the download history storing section stores the communication history so as to be associated with content types, and
wherein the content demanding section refers to the content types to determine whether to demand the content transmission.

20. The rating information collecting terminal device according to claim 16, further comprising a rating information input section operable to cause, after the completion of download of the desired content, the user to input rating information related to said one or more content providing terminal devices and/or content providers of the desired content, and to store the inputted rating information.

21. The rating information collecting terminal device according to claim 20, further comprising a rating information feeding back section operable to feedback the rating information stored by the rating information input section to other rating information collecting terminal devices and rating information storing terminal devices present on the network.

22. The rating information collecting terminal device according to claim 21, wherein the rating information feeding back section transmits the rating information stored by the rating information input section to all the online rating information collecting terminal devices and all the online rating information storing terminal devices.

23. The rating information collecting terminal device according to claim 21, wherein the rating information feeding back section transmits the rating information stored by the rating information input section only to a specific rating information collecting terminal device and/or a specific rating information storing terminal device.

24. The rating information collecting terminal device according to claim 23, wherein the rating information feeding back section transmits the rating information stored by the rating information input section to rating information collecting terminal devices and/or rating information storing terminal devices which have returned rating information in response to a demand to transmit the rating information.

25. The rating information collecting terminal device according to claim 23, wherein the rating information feeding back section transmits the rating information stored by the rating information input section to rating information collecting terminal devices and/or rating information storing terminal devices which have returned rating information, which is different from the rating information stored by the rating information input section, in response to a demand to transmit the rating information.

26. The rating information collecting terminal device according to claim 21, further comprising a rating information updating section operable to update the rating information stored therein based on rating information fed back from another rating information collecting terminal device.

27. The rating information collecting terminal device according to claim 21, further comprising a fed back information transmitting section operable to transmit rating information, which has been fed back from another rating information collecting terminal device, to still another rating information collecting terminal device.

28. The rating information collecting terminal device according to claim 20, further comprising a content rating information input section operable to cause, after reproduction of the desired content, the user to input rating information related to the desired content, and to store the inputted rating information.

29. The rating information collecting terminal device according to claim 9, wherein the rating information indicates rating points for the objects.

30. The rating information collecting terminal device according to claim 9, wherein the rating information indicates distribution of the rating points for the objects.

31. A mutual rating system for rating an object associated with a network, comprising:
a plurality of terminal devices each being connected to the network and having stored therein rating information related to objects previously rated by the user,
wherein each terminal device includes:
a rating information collecting section operable to collect the rating information from other online terminal devices; and
a rating analyzing section operable to analyze the rating information collected by the rating information collecting section to obtain a rating for a desired object.

32. A rating information obtaining program executed by a terminal device for obtaining rating information related to an object associated with a network to which a plurality of rating information storing terminal devices are connected, each rating information storing terminal device having stored therein rating information related to objects previously rated by the user, the rating information obtaining program causing the terminal device to perform the steps of:
collecting rating information related to a desired object from one or more online rating information storing terminal devices; and
analyzing the collected rating information to obtain a rating for the desired object.
